(19) United States
(12) Patent Application Publication
(10) Pub. No.: US 2017/0053580 A1
(43) Pub. Date: Feb. 23, 2017

(54) METHOD FOR DRIVING A DISPLAY AND DISPLAY THEREOF

(71) Applicant: Chunghwa Picture Tubes, Ltd., Taoyuan City (TW)

(72) Inventors: Hui-Ping Chuang, Taoyuan City (TW); Yi-Jui Huang, Taoyuan City (TW); Chiao-Lin Huang, New Taipei City (TW)

(21) Appl. No.: 14/864,898

(22) Filed: Sep. 25, 2015

(30) Foreign Application Priority Data
Aug. 18, 2015 (CN) 201510506257.9

(51) Int. Cl. G09G 3/20; G09G 5/10

(52) U.S. Cl. CPC G09G 3/2003; G09G 5/10; G09G 2320/0276; G09G 2320/0673; G09G 2330/021; G09G 2320/0626

(57) ABSTRACT

A method for driving a display includes a host transmitting a plurality of dynamic frame images to the display, a display panel of the display displaying the plurality of dynamic frame images according to a first gamma table, the host activating a panel self refresh function of the display, and the display panel displaying at least one prior frame image according to a second gamma table after the panel self refresh function is activated. The same grey scale in the first gamma table and the second gamma table corresponds to different gamma voltages. The prior frame images are stored in a memory of the display, and the at least one prior frame image includes at least one dynamic frame image of the plurality of dynamic frame images.

### BACKGROUND OF THE INVENTION

1. Field of the Invention

This invention relates to a method for driving a display, especially relates to a method for driving a display that is able to preserve the display quality after a panel self refresh function of the display is activated.

2. Description of the Prior Art

In prior art, a display may display images according to frame images provided by a host. Since the frame images provided by the host may not be updated continuously but a still image may be displayed instead, unnecessary computation resource and power consumption are wasted if the host keeps generating and transmitting the same frame image to the display. To prevent the host from generating unnecessary frame images when displaying a still image, that is when the host is aware of that the images are not being updated, the host can stop generating the same frame image and the display can simply display the frame image displayed before. Consequently, computation and power consumption of the host can be reduced.

Generally, after the panel self refresh function is activated, the display may display images at a lower frame rate to reduce power consumption. For example, according to the specification of embedded Display Port (eDP) version 1.3, the frame rate of the display will be reduced from 60 Hz to 40 Hz after the panel self refresh function is activated. However, when frame images are displayed at a different frame rate, the brightness of the frame images will be changed accordingly, which can deteriorate the image quality.

### SUMMARY OF THE INVENTION

One embodiment of the present invention discloses a method for driving a display. The method includes a host transmitting a plurality of dynamic frame images to the display, a display panel of the display displaying the plurality of dynamic frame images according to a first gamma table, the host activating a panel self refresh (PSR) function of the display, and the display panel displaying at least one prior frame image according to a second gamma table after the panel self refresh function is activated. The at least one prior frame image comprises at least one dynamic frame image of the plurality of dynamic frame images. A same grey scale in the first gamma table and the second gamma table corresponds to different gamma voltages. The at least one prior frame image is stored in a memory of the display.

Another embodiment of the present invention discloses a display. The display includes a display panel, an image source connector, a memory, a first gamma table, and a second gamma table. The display panel is used to display frame images. The image source connector is used to connect to a host for receiving frame images transmitted from the host. The memory is used to store at least one prior frame image, the first gamma table and the second gamma table. When the host transmits a plurality of dynamic frame images to the display, the display panel displays the plurality of dynamic frame images according to the first gamma table. After a panel self refresh (PSR) function of the display is activated, the display panel displays the least one prior frame image according to a second gamma table. A same grey scale in the first gamma table and the second gamma table corresponds to different gamma voltages. The at least one prior frame image comprises at least one dynamic frame image of the plurality of dynamic frame images.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a display according to one embodiment of the present invention.

FIG. 2 is a flowchart for driving the display of FIG. 1 according to one embodiment of the present invention.

### DETAILED DESCRIPTION

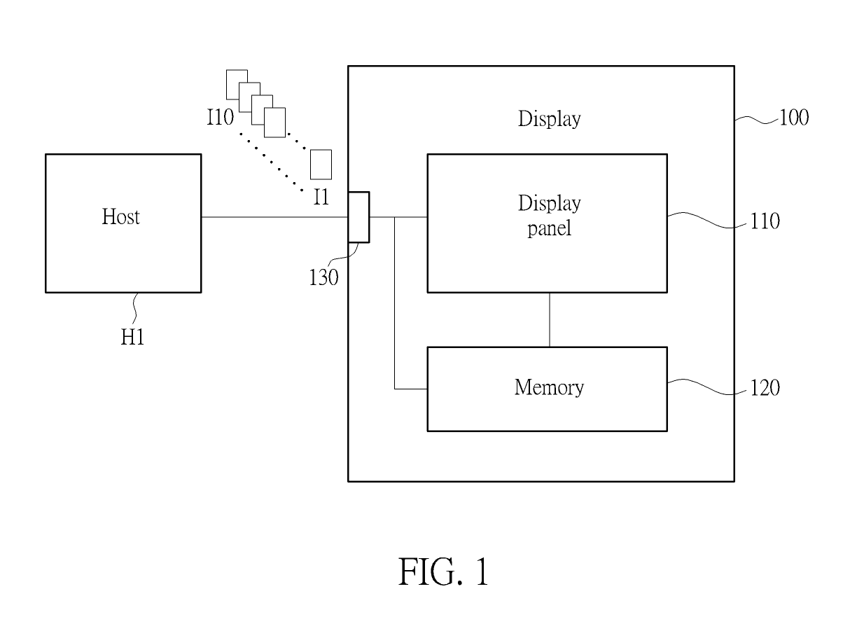

FIG. 1 shows a display 100 according to one embodiment of the present invention. The display 100 includes a display panel 110, a memory 120, and an image source connector 130. The display panel 110 is used for displaying frame images. The display 100 can be a liquid crystal display (LCD) panel, organic light emitting diode (OLED) display panel or other kinds of display panel. The display 100 can connect to the host H1 through the image source connector 130. In some embodiments of the present invention, the host H1 can be a graphic processing unit (GPU) in a computer or other processing unit capable of providing frame images.

The image source connector 130 is used for receiving frame images transmitted from the host H1. In some embodiments of the present invention, the image source connector 130 can be an embedded Display Port (eDP), while in other embodiments, the image source connector 130 can also be compatible with other kinds of image transmission specification.

A plurality of dynamic frame images, ex. dynamic frame images I1 to I10, generated by the host H1 can be transmitted to the display 100 through the image source connector 130 sequentially. When the host H1 transmits the dynamic frame images I1 to I10 to the display 100 sequentially, the display panel 110 can display the dynamic frame images I1 to I10 according to a first gamma table. The first gamma table can be stored in the memory 120.

In addition, when the display 100 receives the dynamic frame images, the display 100 can store the most recently received dynamic frame images to the memory 120 as prior frame images. For example, when the display 100 receives the dynamic frame images I1 to I5, the display 100 may store the dynamic frame images I1 to I5 to the memory 120 as prior image frames. Also, when the display 100 receives the dynamic frame image I6, the display 100 may release the memory space for storing the dynamic frame image I1 in the memory 120 and store the dynamic frame image I6 to the memory 120, ensuring the prior frame images stored in the memory 120 are the five most recently received frame images I2 to I6. In some embodiments, the display 100 may also store only one or even more prior frame images according to the hardware condition of the system.

Consequently, when the host H1 activates a panel self refresh (PSR) function of the display 100, the display panel 110 can display at least one prior frame images stored in the memory 120, such as the dynamic frame images I2 to I6 stored previously, and does not require the host H1 keeps transmitting dynamic frame images to the display 100.

In some embodiments, since the image source connector 130 is compatible to the specification of embedded Display Port version 1.3 and the specification of embedded Display Port version 1.3 has included the content related to the panel self refresh function, the host H1 can activate the panel self refresh function of the display 100 through the image source connector 130 directly. However, in other embodiments, the host H1 may also activate the panel self refresh function of the display 100 by other ways.

Furthermore, when the panel self refresh function of the display 100 is not activated, that is, when the host H1 still transmits dynamic frame images to the display 100, the display panel 110 can display the dynamic frame images transmitted from the host H1 according to the first gamma table at a first frame rate. However, to save even more power after the panel self refresh function is activated, when the panel self refresh function of the display 100 is activated, the display panel 110 can display the prior frame images stored in the memory 120 at a second frame rate, and the first frame rate is greater than the second frame rate.

For example, according to the specification of embedded Display Port version 1.3, the first frame rate before the panel self refresh function is activated may be 60 Hz, and the second frame rate after the panel self refresh function is activated may be 40 Hz. Of course, in other embodiments, the first frame rate and the second frame rate may be other frequencies.

Due to the different frame rates, brightness of a same dynamic frame image displayed by the display panel 110 may be different, which may deteriorate the image quality. Therefore, after the panel self refresh function of the display 100 is activated, the display panel 110 may display the prior frame images stored in the memory 120 according to a second gamma table at the second frame rate. The second gamma table can be stored in the memory 120. Although in FIG. 1, the memory 120 is presented as one single function block, in other embodiments, the memory 120 may also include different blocks and be disposed in different positions in the display 100 to save the prior frame images and the gamma tables.

In the first gamma table and the second gamma table, a same grey level may correspond to different gamma voltages. Therefore, when the grey levels recorded in the frame images are the same, brightness displayed by the display panel 110 according to a gamma voltage corresponding to the first gamma table is different from brightness displayed by the display panel 110 according to a gamma voltage corresponding to the second gamma table.

For example, if the first frame rate is 60 Hz and the second frame rate is 40 Hz, to avoid deteriorating the image quality due to brightness of a frame image displayed by a display panel at a lower frame rate being higher than brightness of the same frame image displayed by the display panel but at a higher frame rate, the absolute value of a first gamma voltage V_{G1} corresponding to a grey level G in the first gamma table can be greater than the absolute value of a second gamma voltage V_{G2} corresponding to the same grey level G in the second gamma table. Consequently, the different brightness displayed by the display panel 110 due to different frame rates can be compensated. In some embodiments, the display panel 110 may require a plurality of gamma voltages to drive pixels, therefore, the first gamma table and the second gamma table may also record the corresponding relations between each of grey levels and the plurality of gamma voltages required by the display panel 110. That is, the first gamma table and the second gamma table are built according the characteristics of the display panel 110 so the brightness of a dynamic frame image displayed by the display panel according to the first gamma table can be substantially equal to the brightness of the dynamic frame image displayed by the display panel according to the second gamma table.

The display panel 110 can look up for gamma voltages according to different gamma tables before and after the panel self refresh function of the display 100 is activated. Therefore, even though the display panel 110 displays frame images with different frame rates before and after the panel self refresh function of the display 100 is activated, the image panel 110 is able to preserve the same brightness when displaying the same frame images so as not to deteriorate the image quality due to the different frame rates.

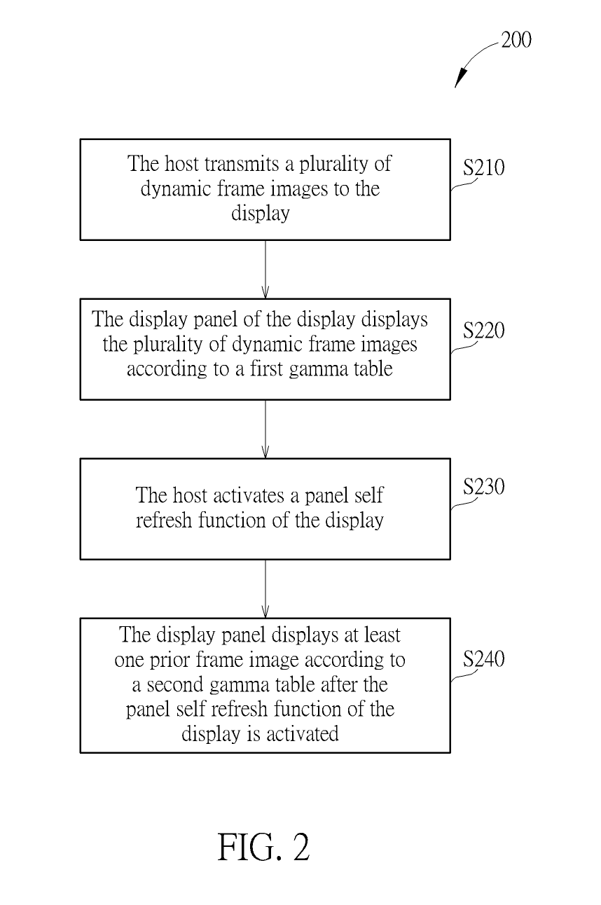

FIG. 2 is a flowchart of a method 200 for driving the display 100. The method 200 includes steps S210 to S240:

S210: the host 100 transmits a plurality of dynamic frame images to the display 100;

S220: the display panel 110 of the display 100 displays the plurality of dynamic frame images according to a first gamma table;

S230: the host H1 activates a panel self refresh function of the display 100;

S240: the display panel 110 displays at least one prior frame image according to a second gamma table after the panel self refresh function of the display 100 is activated.

According to the method 200 for driving the display 100, the display 100 is able to look up for proper gamma voltages according to different gamma tables to preserve the brightness displayed by the display panel 110 before and after the panel self refresh function of the display 100 is activated. Therefore, the prior art issue of image quality deteriorated by different brightness displayed by the display panel due to different frame rates before and after the panel self refresh function is activated can be solved. Further the prior frame image displayed in step S240 may be a frame image displayed in S220.

In summary, the display and the method for driving the display provided by the embodiments of the present invention allow the display to look up for proper gamma voltages according to different gamma tables to preserve the brightness displayed by the display panel 110 before and after the panel self refresh function of the display 100 is activated so that the brightness displayed by the display panel will not be changed with the frame rates. Therefore, the issue of deteriorated image quality in prior art caused by different brightness displayed by the display panel due to different frame rates before and after the panel self refresh function is activated can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for driving a display, comprising:
a host transmitting a plurality of dynamic frame images to the display;
a display panel of the display displaying the plurality of dynamic frame images according to a first gamma table;
the host activating a panel self refresh (PSR) function of the display; and
the display panel displaying at least one prior frame image according to a second gamma table after the panel self refresh function is activated;
wherein:
a same grey scale in the first gamma table and the second gamma table corresponds to different gamma voltages;
the at least one prior frame image is stored in a memory of the display; and
the at least one prior frame image comprises at least one dynamic frame image of the plurality of dynamic frame images.

2. The method of claim 1, wherein:
the display panel displays the plurality of dynamic frame images according to the first gamma table at a first frame rate; and
the display panel displays the at least one prior frame image according to the second gamma table at a second frame rate.

3. The method of claim 2, wherein the first frame rate is greater than the second frame rate.

4. The method of claim 3, wherein an absolute value of a first gamma voltage corresponding to a gray level in the first gamma table is greater than an absolute value of a second gamma voltage corresponding to the gray level in the second gamma table.

5. The method of claim 1, wherein brightness of a dynamic frame image displayed by the display panel according to the first gamma table is substantially equal to brightness of the dynamic frame image displayed by the display panel according to the second gamma table.

6. The method of claim 1, wherein the host and the display are connected through an embedded Display Port (eDP).

7. A display, comprising:
a display panel configured to display frame images;
an image source connector configured to connect to a host for receiving frame images transmitted from the host;
a memory configured to store at least one prior frame image;
a first gamma table stored in the memory; and
a second gamma table stored in the memory;
wherein:
when the host transmits a plurality of dynamic frame images to the display, the display panel displays the plurality of dynamic frame images according to the first gamma table;
after a panel self refresh (PSR) function of the display is activated, the display panel displays the least one prior frame image according to the second gamma table;
a same grey scale in the first gamma table and the second gamma table corresponds to different gamma voltages; and
the at least one prior frame image comprises at least one dynamic frame image of the plurality of dynamic frame images.

8. The display of claim 7, wherein:
when the host transmits the plurality of dynamic frame images to the display, the display panel displays the plurality of dynamic frame images according to the first gamma table at a first frame rate; and
after the panel self refresh (PSR) function of the display is activated, the display panel displays the least one prior frame image according to the second gamma table at a second frame rate.

9. The display of claim 8, wherein the first frame rate is greater than the second frame rate.

10. The display of claim 9, wherein an absolute value of a first gamma voltage corresponding to a gray level in the first gamma table is greater than an absolute value of a second gamma voltage corresponding to the gray level in the second gamma table.

11. The display of claim 7, wherein brightness of a dynamic frame image displayed by the display panel according to the first gamma table is substantially equal to brightness of the dynamic frame image displayed by the display panel according to the second gamma table.

12. The display of claim 7, wherein the image source connector is an embedded Display Port (eDP).
